(19) United States
(12) Patent Application Publication
(10) Pub. No.: US 2009/0197062 A1
(43) Pub. Date: Aug. 6, 2009

(54) Magnetic thin film and thin film magnetic device

(75) Inventor: Taku MASAI, Tokyo (JP)

Correspondence Address: OLIFF & BERRIDGE, PLC, P.O. BOX 320850, ALEXANDRIA, VA, 22320-4850, US

(73) Assignee: TDK CORPORATION, Tokyo (JP)

(21) Appl. No.: 12/320,179

(22) Filed: Jan. 21, 2009

(30) Foreign Application Priority Data
Jan. 31, 2008 (JP) 2008-020193

(51) Int. Cl. B32B 7/02

(52) U.S. Cl. 428/213

(57) ABSTRACT

A magnetic thin film includes: a first magnetic film formed on a substrate; and a second magnetic film formed on the first magnetic film. The first magnetic film is a soft magnetic film having magnetic permeability higher than that of the second magnetic film. The second magnetic film is an iron-based soft magnetic film. Thickness ratio between the first magnetic film and the second magnetic film (=thickness of the first magnetic film/thickness of the second magnetic film) lies in a range of 0.005 to 0.030 both inclusive.

### CROSS REFERENCE TO RELATED APPLICATIONS

The present invention contains subject matter related to Japanese Patent Application JP 2008-020193 filed in the Japanese Patent Office on Jan. 31, 2008, the entire contents of which being incorporated herein by reference.

### BACKGROUND OF THE INVENTION

1. Field of the Invention

The present invention relates to a magnetic thin film including a soft magnetic film, and to a thin film magnetic device having the magnetic thin film.

2. Description of the Related Art

In electronic device fields for various uses, thin film magnetic devices such as a thin film inductor and a thin film transformer, each including a thin film coil and a magnetic thin film (soft magnetic thin film), are widely used as integrated passive components.

In recent years, a soft magnetic thin film for use in such a thin film magnetic device or the like having high magnetic permeability is in demand. For example, Japanese Unexamined Patent Application Publication No. 2006-86421 proposes a technique for improving magnetic permeability of a soft magnetic thin film (granular film) by a heat treatment process.

### SUMMARY OF THE INVENTION

Since magnetic permeability of a soft magnetic thin film having improved high frequency characteristic is generally low, a request for higher permeability is conspicuous. Therefore, further improvement in the magnetic permeability in the soft magnetic thin film is demanded.

It is thus desirable to provide a magnetic thin film capable of effectively improving magnetic permeability of the soft magnetic thin film, and to provide a thin film magnetic device having the magnetic thin film.

A first magnetic thin film as an embodiment of the present invention has: a first magnetic film formed on a substrate; and a second magnetic film formed on the first magnetic film. The first magnetic film is a cobalt (Co)-based amorphous soft magnetic film, and the second magnetic film is an iron (Fe)-based soft magnetic film. The thickness ratio between the first magnetic film and the second magnetic film (=thickness of the first magnetic film/thickness of the second magnetic film) lies in a range of 0.005 to 0.030 both inclusive.

A first thin film magnetic device of the present invention has: a thin film coil; and the first magnetic thin film formed, along a formation plane of the thin film coil, on at least one of an upper side and lower side of the thin film coil. The first magnetic thin film includes: a first magnetic film formed along the formation plane of the thin film coil; and a second magnetic film formed on the first magnetic film.

In the first magnetic thin film and the first thin film magnetic device as embodiments of the present invention, the Fe-based soft magnetic film is formed on the Co-based amorphous soft magnetic film (first magnetic film) as a soft magnetic film having magnetic permeability higher than that of the Fe-based soft magnetic film (second magnetic film). With the configuration, magnetization reversal of the Fe-based soft magnetic film is assisted by easy magnetization reversal in the Co-based amorphous soft magnetic film, and magnetization reversal in the Fe-based soft magnetic film is facilitated. Since the film thickness ratio between the Co-based amorphous soft magnetic film and the Fe-based soft magnetic film is set in a proper range, the influence of stress from the Co-based amorphous soft magnetic film to the Fe-based soft magnetic film is reduced, and deterioration in the magnetic property caused by the stress (such as drop in the magnetic permeability) is reduced.

A second magnetic thin film as an embodiment of the present invention has a first magnetic film formed on a substrate, and a second magnetic film formed on the first magnetic film. The first magnetic film is a soft magnetic film having magnetic permeability higher than that of the second magnetic film, and the second magnetic film is an iron (Fe)-based soft magnetic film. Thickness ratio between the first magnetic film and the second magnetic film (=thickness of the first magnetic film/thickness of the second magnetic film) lies in a range of 0.005 to 0.030 both inclusive.

A second thin film magnetic device as an embodiment of the present invention has a thin film coil and the second magnetic thin film stacked on at least one of extending faces of the thin film coil. The second magnetic thin film has: a first magnetic film stacked on an extending face of the thin film coil; and a second magnetic film stacked on the first magnetic film.

In the second magnetic thin film and the second thin film magnetic device as embodiments of the present invention, the Fe-based soft magnetic film is formed on a soft magnetic film (first magnetic film) having magnetic permeability higher than that of the Fe-based soft magnetic film (second magnetic film). With the configuration, magnetization reversal of the Fe-based soft magnetic film is assisted by easy magnetization reversal in the first magnetic film, and magnetization reversal in the Fe-based soft magnetic film is facilitated. Since the film thickness ratio between the first magnetic film and the Fe-based soft magnetic film is set in a proper range, the influence of stress from the first magnetic film to the Fe-based soft magnetic film is reduced, and deterioration in the magnetic property caused by the stress (such as drop in the magnetic permeability) is reduced.

In the magnetic thin film of the present invention, preferably, coercive force (Hc) of the first magnetic film is 1.1 Oe or less. With such a configuration, the magnetic permeability of the first magnetic film becomes higher, so that magnetization reversal in the first magnetic film becomes easier. Therefore, the assisting action of the magnetization reversal of the Fe-based soft magnetic film by the first magnetic film is performed more effectively, and the magnetic permeability in the magnetic thin film as a whole further improves.

In the magnetic thin film as an embodiment of the present invention, preferably, ratio between saturation magnetization (Ms) and anisotropy field (Hk) in the first magnetic film (=Ms/Hk) and ratio between saturation magnetization (Ms) and anisotropy field (Hk) in the second magnetic film (=Ms/Hk) are substantially equal to each other. With such a configuration, the magnetization reversal speeds in the first and second magnetic fields become almost equal to each other. Consequently, the assisting action of the magnetization reversal of the Fe-based soft magnetic film by the first magnetic film is made more effectively. The magnetic permeability of the magnetic thin film as a whole further improves.

In the first magnetic thin film and the first thin film magnetic device as embodiments of the present invention, the Fe-based soft magnetic film is formed on the Co-based amorphous soft magnetic film (first magnetic film) as a soft magnetic film having magnetic permeability higher than that of the Fe-based soft magnetic film (second magnetic film). With the configuration, magnetization reversal of the Fe-based soft magnetic film is facilitated, and magnetic permeability of the magnetic thin film as a whole can be improved. Since the film thickness ratio between the Co-based amorphous soft magnetic film and the Fe-based soft magnetic film is set in a proper range, decrease in the magnetic permeability due to the influence of the stress can be suppressed. Therefore, the magnetic permeability of the soft magnetic thin film can be improved more effectively as compared with the conventional technique.

In the second magnetic thin film and the second thin film magnetic device as embodiments of the present invention, the Fe-based soft magnetic film is formed on a soft magnetic film (first magnetic film) having magnetic permeability higher than that of the Fe-based soft magnetic film (second magnetic film). With the configuration, magnetization reversal of the Fe-based soft magnetic film is facilitated, and magnetic permeability of the magnetic thin film as a whole can be improved. Since the thickness ratio between the first magnetic film and the Fe-based soft magnetic film is set in a proper range, so that decrease in the magnetic permeability due to the influence of stress can be suppressed. Therefore, the magnetic permeability of the soft magnetic thin film can be improved more effectively as compared with the conventional technique.

Other and further objects, features and advantages of the invention will appear more fully from the following description.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the specification, serve to explain the principles of the invention.

FIG. 1 is a plan view illustrating a configuration of a thin film magnetic device according to an embodiment of the present invention.

FIG. 2 is a cross-sectional view illustrating a sectional configuration of the thin film magnetic device taken along line II-II of FIG. 1.

FIG. 3 is a cross-sectional view illustrating a stacked structure in a lower magnetic film and an upper magnetic film illustrated in FIG. 2.

FIGS. 4A and 4B are cross-sectional views for explaining a method of manufacturing the thin film magnetic device illustrated in FIG. 1.

FIGS. 5A and 5B are cross-sectional views for explaining the details of a method of forming the lower magnetic film illustrated in FIGS. 4A and 4B.

FIGS. 6A to 6C are cross-sectional views for explaining the method of manufacturing the thin film magnetic device continued from FIG. 4B.

FIGS. 7A to 7C are cross-sectional views for explaining the method of manufacturing the thin film magnetic device continued from FIG. 6C.

FIGS. 8A to 8C are cross-sectional views for explaining the method of manufacturing the thin film magnetic device continued from FIG. 7C.

FIGS. 9A and 9B are cross-sectional views for explaining the method of manufacturing the thin film magnetic device continued from FIG. 8C.

FIG. 10 is a plan view for explaining the method of manufacturing the thin film magnetic device continued from FIG. 9B.

FIG. 11 is a micrograph representing an example of a crystal structure of a Co-based amorphous soft magnetic film illustrated in FIG. 3.

FIG. 12 is an exploded perspective view for explaining the assisting action of magnetization reversal.

FIG. 13 is a characteristic diagram representing an example of the relations between a film thickness ratio of the Co-based amorphous soft magnetic film and an Fe-based soft magnetic film in the magnetic film illustrated in FIG. 2 and increasing rate of the magnetic permeability.

FIG. 14 is a characteristic diagram representing an example of the relations between thickness of the Co-based amorphous soft magnetic film in the magnetic film illustrated in FIG. 2 and increasing rate of the magnetic permeability.

FIG. 15 is a characteristic diagram representing an example of the relation between the film configuration in the magnetic film illustrated in FIG. 2 and increasing rate of the magnetic permeability.

FIG. 16 is a characteristic diagram representing an example of the relation between thickness of the Fe-based soft magnetic film illustrated in FIG. 3 and coercive force in the Co-based amorphous soft magnetic film.

FIG. 17 is a diagram representing an example of the relation between the ratio of saturation magnetization and anisotropy field in the Fe-based soft magnetic film and an effect of increase in the magnetic permeability in the magnetic film.

FIG. 18 is a characteristic diagram representing a magnetization curve in the magnetic film when data of the saturation magnetization and the anisotropy field represented in FIG. 17 are obtained.

FIGS. 19A and 19B are characteristic diagrams representing an example of the relation between Fe relative proportion in the Fe-based soft magnetic film and saturation magnetization and the relation between Co relative proportion in the Co-based amorphous soft magnetic film and saturation magnetization, respectively.

FIG. 20 is a cross-sectional view illustrating a configuration of a thin film magnetic device according to a first modification of the embodiment of the present invention.

FIG. 21 is a cross-sectional view illustrating a configuration of the thin film magnetic device according to a second modification of the embodiment of the present invention.

FIG. 22 is a perspective view illustrating a configuration of the thin film magnetic device according to a third modification of the embodiment of the present invention.

### DETAILED DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts. The scope of the present invention, however, is not limited to these embodiments. Within the scope of the present invention, any structure and material described below can be appropriately modified.

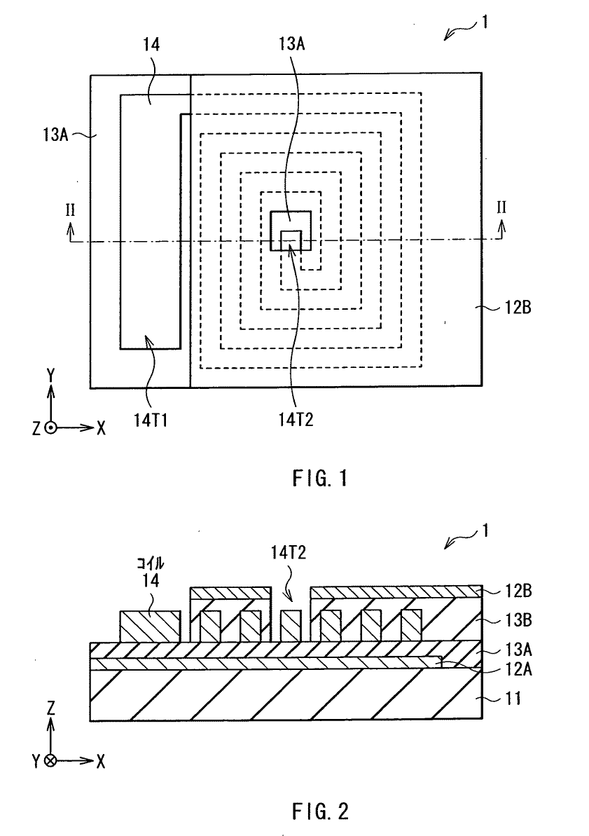

FIGS. 1 and 2 illustrate a configuration of a thin film inductor 1 as a thin film magnetic device according to an embodiment of the present invention. FIG. 1 illustrates an X-Y plane configuration, and FIG. 2 illustrates an X-Z sectional configuration taken along line II-II illustrated in FIG. 1. The thin film inductor 1 has a stack structure in which a lower magnetic film 12A, a lower insulating film 13A, a thin film coil 14, an upper insulating film 13B, and an upper magnetic film 12B are formed in this order on a substrate 11.

The substrate 11 is a rectangular substrate supporting the whole thin film inductor 1, and is made of, for example, glass, aluminum oxide (Al₂O₃, so-called alumina), ceramics such as ferrite, semiconductor such as silicon (Si), a resin, or the like. The material of the substrate 11 is not necessarily limited to any of the above described series of materials but can be freely selected.

The lower insulating film 13A and the upper insulating film 13B are provided to electrically insulate the coil 14 from the periphery, and are made of, for example, an insulating material such as silicon oxide (SiO₂).

In the coil 14, an inductor is constructed between one end (terminal 14T1) and the other end (terminal 14T2). The coil 14 is made of a conductive material such as copper (Cu) or the like. The coil 14 has a rectangular spiral structure wound so that both of the terminals 14T1 and 14T2 are led to the outside in the X-Y plane. In order to lead both of the terminals 14T1 and 14T2 to the outside, as illustrated in FIGS. 1 and 2, the upper insulating film 13B and the upper magnetic film 12B are not stacked around the terminals 14T1 and 14T2.

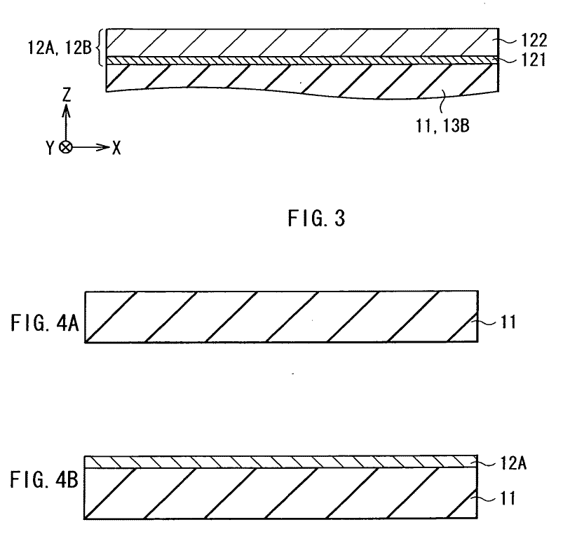

The lower magnetic film 12A and the upper magnetic film 12B are provided to increase the inductance of the thin film inductor 1. The lower magnetic film 12A and the upper magnetic film 12B have, for example, an X-Z sectional configuration as illustrated in FIG. 3. Specifically, the lower and upper magnetic films 12A and 12B have a stack structure in which a cobalt (Co)-based amorphous soft magnetic film 121 and an iron (Fe)-based soft magnetic film 122 are formed in this order on the substrate 11 or on the upper insulating film 13B.

The Co-based amorphous soft magnetic film 121 is an under layer of the Fe-based soft magnetic film 122, and is a soft magnetic film having magnetic permeability higher than that of the Fe-based soft magnetic film 122. The Co-based amorphous soft magnetic film 121 is made of, for example, cobalt zirconium tantalum (CoZrTa), cobalt zirconium niobium (CoZrNb), or the like. Preferably, the Co-based amorphous soft magnetic film 121 may be formed to come to a state where, for example, hexagonal crystal with a microcrystal size of 10 nm is included so as to have the coercive force. In such a state, fine particles of Co single crystal are existing in a dispersed manner. Further, the coercive force (Hc) of the Co-based amorphous soft magnetic film 121 is preferably 1.1 [Oe] or less. Thereby, as the details will be described later, the magnetic permeability of the magnetic thin film (the lower and upper magnetic films 12A and 12B) can be further improved.

The Fe-based soft magnetic film 122 is made of, preferably, Fe-M (M: metal element of at least one of group IIIa, group IVa, and group Va)-O based material. An Fe—Y—O based material is more preferable. The reason why the Fe—Y—O-based material is more preferable is that Y is oxidized very easily due to its particularly high free energy of Gibbs among rare earths, and thus the layer of Y and the layer of Fe are easily separated from each other, and the granular structure is easily produced. Preferably, the Fe-based soft magnetic film 122 is a granular film. As used herein, the granular film includes not only a state where a magnetic substance (Fe) is dispersed in the form of particles in a non-magnetic substance, but also a state where the magnetic substance is grown largely in a column shape.

In both of the lower and upper magnetic films 12A and 12B according to the present embodiment, the film thickness ratio between the Co-based amorphous soft magnetic film 121 and the Fe-based soft magnetic film 122 (=thickness of the Co-based amorphous soft magnetic film 121/thickness of the Fe-based soft magnetic film 122) is set to the range of 0.005 to 0.030 both inclusive. Thereby, as the details will be described later, the influence of stress from the Co-based amorphous soft magnetic film 121 to the Fe-based soft magnetic film 122 is reduced, and thus reduction in the magnetic permeability in the magnetic thin film (the lower and upper magnetic films 12A and 12B) due to the influence of such a stress is suppressed. In addition, preferably, the ratio between saturation magnetization (Ms(Co) which will be described later) and anisotropy field (Hk(Co) which will be described later) in the Co-based amorphous soft magnetic film 121 (=Ms (Co)/Hk(Co)) and the ratio between the saturation magnetization (Ms(Fe) which will be described later) and anisotropy field (Hk(Fe) which will be described later) in the Fe-based soft magnetic film 122 (=Ms(Fe)/Hk(Fe)) are almost equal to each other. Thereby, as the details will be described later, magnetization reversal speed in the Co-based amorphous soft magnetic film 121 and that in the Fe-based soft magnetic film 122 become almost equal to each other, and thus the magnetic permeability of the magnetic thin film (the lower and upper magnetic films 12A and 12B) as a whole can be further improved.

The lower and upper magnetic films 12A and 12B can be one example of “magnetic thin film”. The Co-based amorphous soft magnetic film 121 can be one example of the “first magnetic film”, and the Fe-based soft magnetic film 122 can be one example of the “second magnetic film”, although they are not limited thereto.

Referring now to FIGS. 4A to 10, an example of the method of manufacturing the thin film inductor 1 will be described. FIGS. 4A and 4B to FIG. 10 illustrate an example of the method of manufacturing the thin film inductor 1. FIGS. 4A and 4B to FIGS. 9A and 9B illustrate an X-Z sectional configuration, and FIG. 10 illustrates an X-Y sectional configuration.

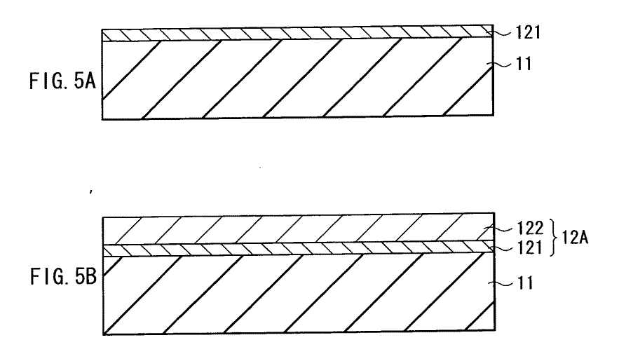

First, as illustrated in FIGS. 4A and 4B, the lower magnetic film 12A is uniformly formed on the substrate 11 made of the above-described material. The lower magnetic film 12A is formed by, for example, sputtering. Specifically, as illustrated in FIG. 5A, the Co-based amorphous soft magnetic film 121 made of the above-described material is uniformly formed on the substrate 11, and thereafter, as illustrated in FIG. 5B, the Fe-based soft magnetic film 122 is uniformly formed on the Co-based amorphous soft magnetic film 121. At the time of forming the Co-based amorphous soft magnetic film 121, the film forming pressure is set to, for example, about 0.66 Pa. For example, in the case of using a CoZrTa film, the relative proportion (at %) is set so that Co:Zr:Ta=about 93:4:3 is established. At the time of forming the Fe-based soft magnetic film 122, the film forming pressure is set to, for example, about 0.30 Pa. For example, in the case of using an Fe—Y—O film, the relative proportion (at %) is set so that Fe:Y:O=about 77:9:14 is established. At this time, as described above, the thickness relation of the Co-based amorphous soft magnetic film 121 and the Fe-based soft magnetic film 122 lies in the range of 0.005 to 0.030 both inclusive.

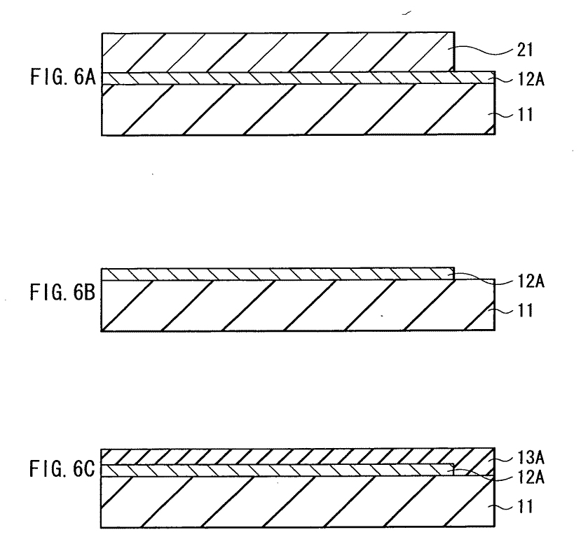

Subsequently, as illustrated in FIGS. 6A and 6B, the photoresist pattern 21 is formed and, by using photolithography, the lower magnetic film 12A is etched in a predetermined pattern as illustrated in FIGS. 1 and 2 for example.

Thereafter, as illustrated in FIG. 6C, the lower insulating film 13A made of the above-described material is uniformly formed on the substrate 11 and on the lower magnetic film 12A. The lower insulating film 13A is formed by, for example, sputtering.

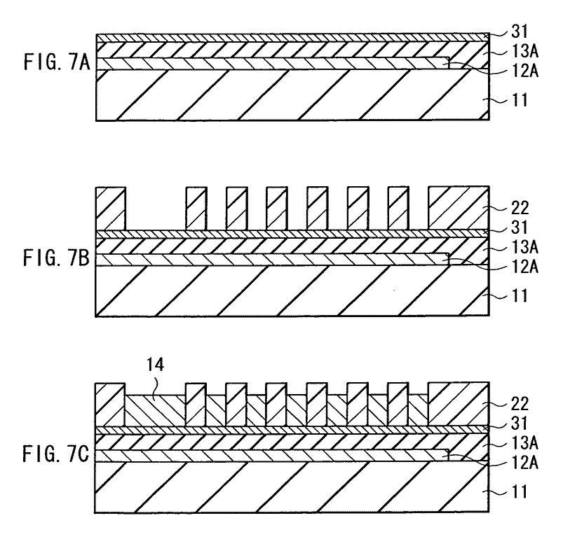

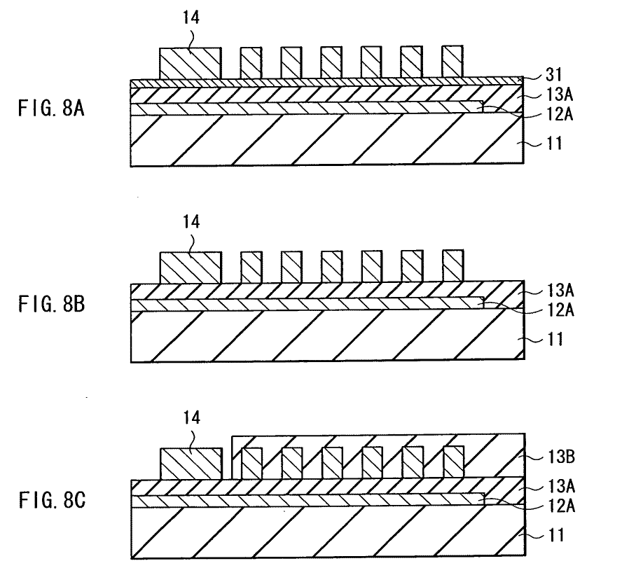

As illustrated in FIGS. 7A to 7C and FIGS. 8A and 8B, the coil 14 in a predetermined pattern and made of the above-described material is formed on the lower insulting film 13A. The coil 14 is formed by, for example, plating. Specifically, first, as illustrated in FIG. 7A, a plating seed layer 31 made of Cr/Cu or the like is uniformly formed on the lower insulting film 13A by using, for example, sputtering. Then, as illustrated in FIG. 7B, a photoresist pattern 22 for patterning the coil 14 is formed on the plating seed layer 31. Subsequently, illustrated in FIG. 7C, the coil 14 in the predetermined pattern and made of the above-described material is formed on the plating seed layer 31 by using plating for example. Then, as illustrated in FIGS. 8A and 8B, the photoresist pattern 22 and the plating seed layer 31 are removed with a predetermined resist removing material or the like, and thereby, the coil 14 as illustrated in FIG. 8B is formed.

Subsequently, as illustrated in FIG. 8C, the upper insulating film 13B made of the above-described material is formed in the predetermined pattern illustrated for example in FIGS. 1 and 2 on the lower insulating film 13A and on the coil 14. The upper insulating film 13B is formed by filling a resin by, for example, printing photolithography, or the like.

Subsequently, as illustrated in FIG. 8C, the upper insulating film 13B made of the above-described material is formed in the predetermined pattern illustrated for example in FIGS. 1 and 2 on the lower insulating film 13A and on the coil 14. The upper insulating film 13B is formed by using, for example, sputtering and photolithography.

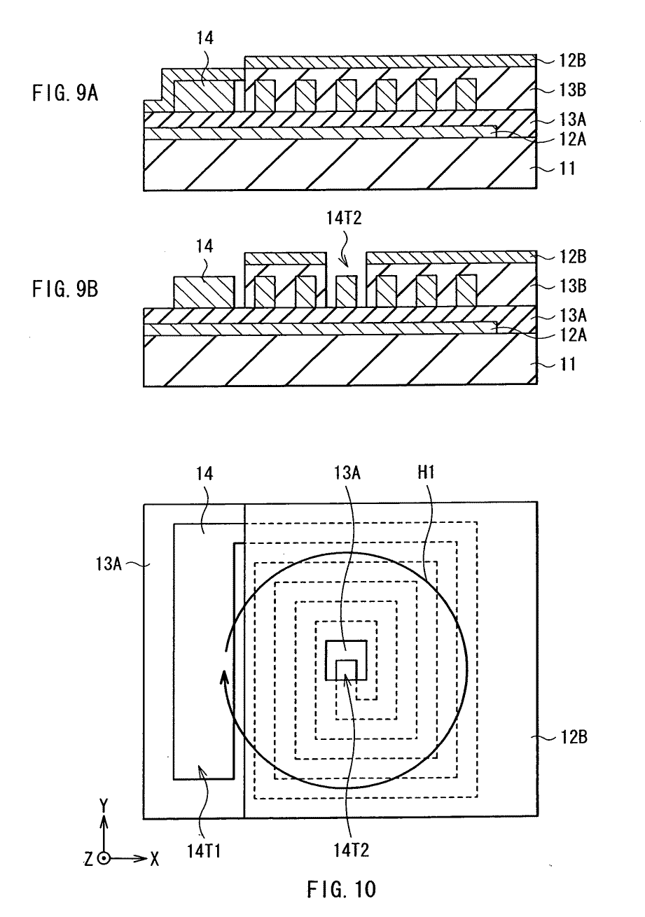

As illustrated in FIG. 9A, the upper magnetic film 12B made of the Co-based amorphous soft magnetic film 121 and the Fe-based soft magnetic film 122 is uniformly formed on the lower insulating film 13A, the upper insulating film 13B, and the coil 14. The upper magnetic film 12B is formed by, for example, sputtering in a manner similar to the formation of the lower magnetic film 12A.

Subsequently, as illustrated in FIG. 9B, the upper magnetic film 12B is etched in a predetermined pattern illustrated for example in FIGS. 1 and 2 by using, for example, photolithography. As a result, the terminal 14T2 as illustrated in the drawing is formed.

Finally, as illustrated in FIG. 10, heat treatment is performed while applying a rotating magnetic field H1 in a stack plane (X-Y plane) of the lower magnetic film 12A and the upper magnetic film 12B. The magnitude of the rotating magnetic field H1 is, for example, about 300×10³/4π [A/m] (=300 Oe). For example, the number of rotations of the rotating magnetic field H1 is set to about 90 rpm, heat treatment temperature is set to about 330° C., and the heat treatment time is set to about one hour. By the heat treatment in the rotating magnetic field, the stress in the lower magnetic film 12A and the upper magnetic film 12B is lessened and magnetic anisotropies thereof are reduced. In such a manner, the thin film inductor 1 as illustrated in FIGS. 1 to 3 according to the present embodiment is manufactured.

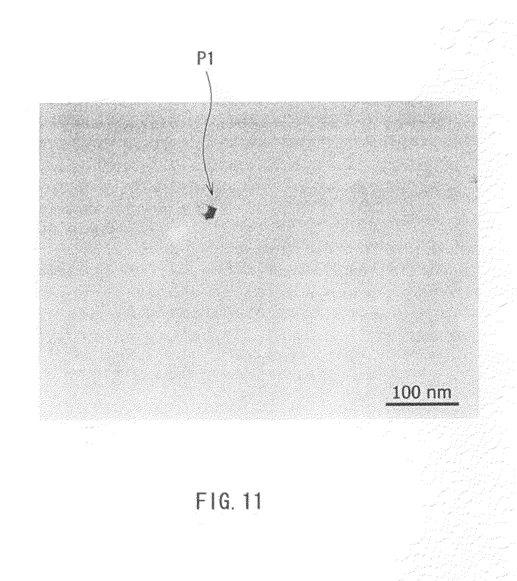

Referring now to FIG. 11 to FIGS. 19A and 19B, the action and effect of the thin film inductor 1 according to the present embodiment will be described in detail while representing the magnetic characteristics of the thin film inductor 1 manufactured in such a manner.

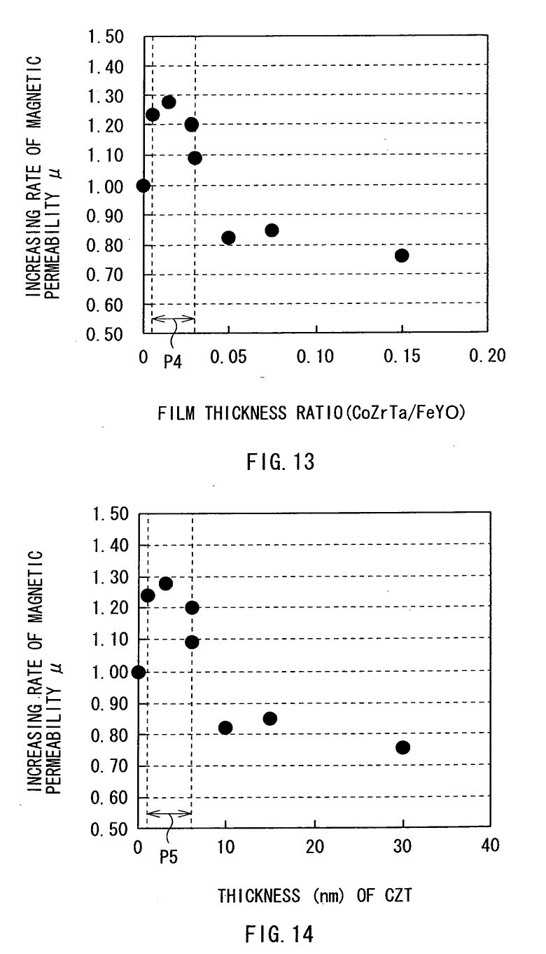

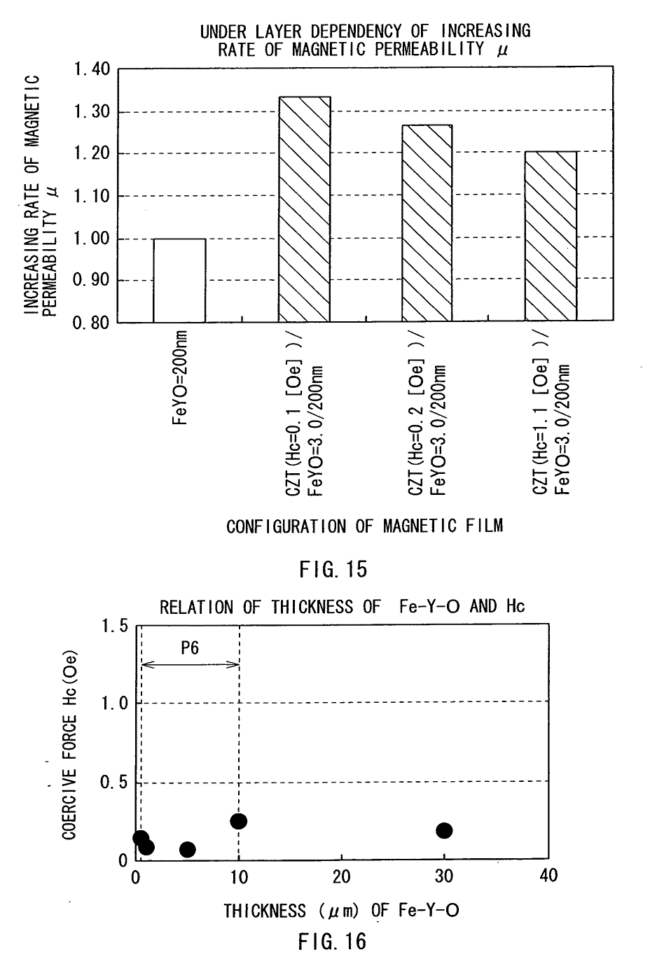

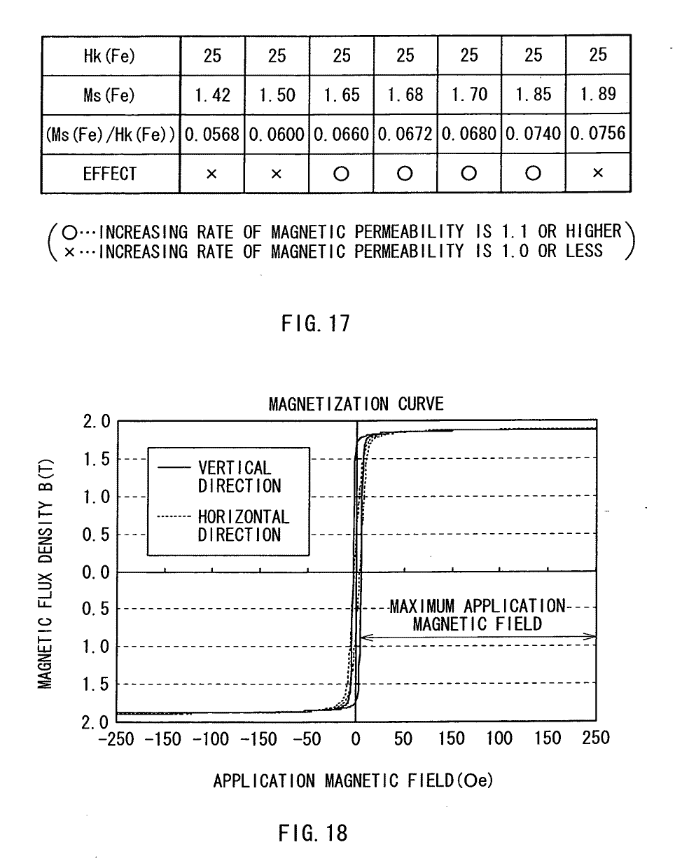

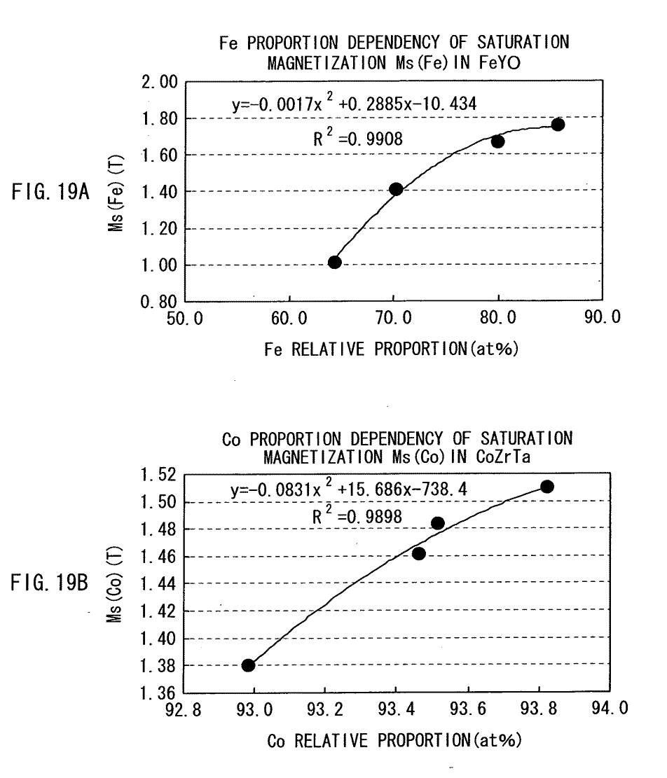

FIG. 11 is a micrograph taken by the Bitter method using magnetic colloid and enlargedly representing an example of a plane shape of the Co-based amorphous soft magnetic film 121 in the lower and upper magnetic films 12A and 12B. FIG. 13 represents an example of the relations between a film thickness ratio of the Co-based amorphous soft magnetic film 121 and the Fe-based soft magnetic film 122 in the lower and upper magnetic films 12A and 12B and increasing rate of the magnetic permeability μ. FIG. 14 represents an example of the relations between thickness of the Co-based amorphous soft magnetic film 121 and increasing rate of the magnetic permeability μ. FIG. 15 represents an example of the relation between the film configuration in the lower and upper magnetic films 12A and 12B and increasing rate of the magnetic permeability μ. FIG. 16 represents an example of the relation between thickness of the Fe-based soft magnetic film 122 and coercive force Hc in the Co-based amorphous soft magnetic film 121. FIG. 17 represents an example of the relation between the ratio (Ms(Fe)/Hk(Fe)) of saturation magnetization Ms(Fe) and anisotropy field Hk(Fe) in the Fe-based soft magnetic film 122 and an effect of increase in the magnetic permeability μ. FIG. 19A represents an example of the relation between Fe relative proportion in the Fe-based soft magnetic film 122 and saturation magnetization Ms(Fe). FIG. 19B represents an example of the relation between Co relative proportion in the Co-based amorphous soft magnetic film 121 and the saturation magnetization Ms(Co).

The manufacturing conditions of the thin film inductor 1 in the examples are as follows. First, the lower and upper magnetic films 12A and 12B are formed by using DC magnetron sputtering. A CoZrTa (CZT) thin film is used as the Co-based amorphous soft magnetic film 121 in the lower and upper magnetic films 12A and 12B, and an Fe—Y—O (FeYO) thin film is used as the Fe-based soft magnetic film 122.

First, as denoted by reference numeral P1 in FIG. 11, it can be seen that most of the Co-based amorphous soft magnetic film 121 (in this example, CZT thin film) has an amorphous structure. Thereby, without being influenced by crystallinity of Co, the Fe-based soft magnetic film 122 (in this example, Fe—Y—O thin film) as an upper layer thereof can be formed with reduced stress.

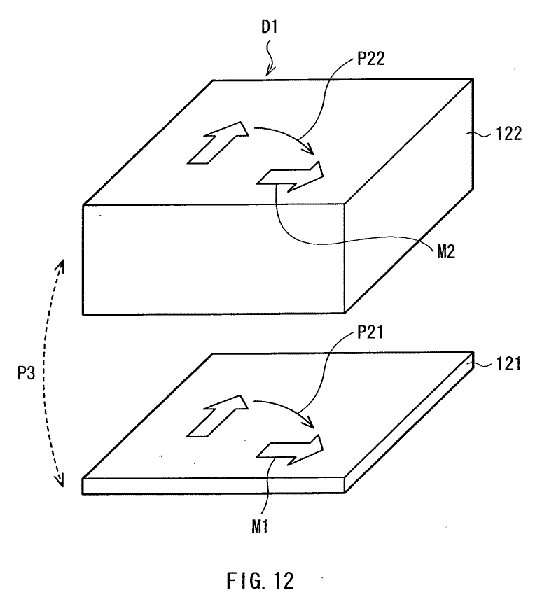

In the thin film inductor 1 according to the present embodiment, as described above, the Fe-based soft magnetic film 122 is formed on the Co-based amorphous soft magnetic film 121 as a soft magnetic film having magnetic permeability higher than that of the Fe-based soft magnetic film 122. Thereby, when easy (smooth) magnetization reversal (for example, reversal of the magnetization M1 in the drawing) is performed in the Co-based amorphous soft magnetic film 121 as denoted by arrows P21 and P22 in FIG. 12, for example, the magnetization reversal (for example, the magnetization reversal of the magnetization M2 in the drawing) is assisted by magnetostatic energy between the Co-based amorphous soft magnetic film 121 and the Fe-based soft magnetic film 122 as denoted by arrow P3 in the drawing, and thus magnetization reversal in the Fe-based soft magnetic film 122 becomes easy.

In the thin film inductor 1 of the present embodiment, for example, as denoted by reference numeral P4 in FIG. 13, the thickness ratio between the Co-based amorphous soft magnetic film 121 and the Fe-based soft magnetic film 122 (=thickness of the Co-based amorphous soft magnetic film 121/thickness of the Fe-based soft magnetic film 122) is set in the range of 0.005 to 0.030. Thereby, the influences of stresses between the two soft magnetic films (compression stress in the Co-based amorphous soft magnetic film 121 and tensile stress in the Fe-based soft magnetic film 122) cancel each other. Hence, decrease in the permeability of the whole magnetic thin film (the lower and upper magnetic films 12A and 12B) due to the influence of such stresses is suppressed.

Preferably, the Co-based amorphous soft magnetic film 121 (in the example, CZT thin film) is as thin as possible. Specifically, for example, the thickness is preferably in the range of 1 nm to 6 nm both inclusive as denoted by reference numeral P5 in FIG. 14. When the Co-based amorphous soft magnetic film 121 is thicker than that thickness, stress applied to the Fe-based soft magnetic film 122 as an upper layer thereof becomes too large, and consequently, the magnetic permeability of the whole magnetic thin film (the lower magnetic film 12A and the upper magnetic film 12B) decreases. On the other hand, when the thickness of the Co-based amorphous soft magnetic film 121 is in the range, there is hardly any influence of the stress.

In the thin film inductor 1 of the present embodiment, as understood from the under layer dependency of the increasing rate of the magnetic permeability μ represented in FIG. 15 for example, the coercive force (Hc) of the Co-based amorphous soft magnetic film 121 is preferably 1.1 Oe or less, and smaller coercive force (Hc) is desirable. By employing such a configuration, the magnetic permeability of the Co-based amorphous soft magnetic film 121 further increases, so that the magnetization in the Co-based amorphous soft magnetic film 121 is reversed more easily (more smoothly). Thereby, assisting action of the magnetization reversal in the Fe-based soft magnetic film 122 by the Co-based amorphous soft magnetic film 122 is performed more effectively, and the magnetic permeability of the whole magnetic thin film (the lower and upper magnetic films 12A and 12B) improves further.

In FIG. 15, the case where the thickness ratio between the Co-based amorphous soft magnetic film 121 and the Fe-based soft magnetic film 122 is “3.0 nm/200 nm” has been described. Also in the case where the thickness ratio between the Co-based amorphous soft magnetic film 121 and the Fe-based soft magnetic film 122 is another value, the coercive force (Hc) of the Co-based amorphous soft magnetic film 121 is still preferably 1.1 Oe or less. This is because, since in the Co-based amorphous soft magnetic film 121the coercive force is almost constant irrespective of the film thickness, the stress balance becomes the same even when the film thickness varies as long as the ratio is the same. However, in the case where the Fe-based soft magnetic film 122 is thick (for example, when the thickness is 10 μm or larger), the magnetization reversal is disturbed by the stress of the film itself. Hence, for example, as denoted by reference numeral P6 in FIG. 16, the thickness of the Fe-based soft magnetic film 122 is desirably in the range of about 100 nm to 10 μm.

In the thin film inductor 1 of the present embodiment, preferably, the magnetization reversal speed in the Co-based amorphous soft magnetic film 121 and that in the Fe-based soft magnetic film are almost equal to each other. Thereby, the above-described assisting action of the magnetization reversal of the Fe-based soft magnetic film 122 is performed more effectively by the Co-based amorphous soft magnetic film 121, and thus the magnetic permeability of the whole magnetic thin film (the lower and upper magnetic films 12A and 12B) is further improved.

Here, when the angle of magnetization to the magnetic field is φ and time is “t”, the magnetization reversal speed in the soft magnetic film is expressed as (dφ/dt) as represented in the following equation (1). In addition, the magnetization reversal speed (dφ/dt) is correlated with the saturation magnetization Ms and the anisotropy field Hk, and is expressed likewise by a relational expression represented, for example, by the equation (1). For example, increase in the anisotropy field Hk, decrease in the saturation magnetization Ms and so forth denote decrease in the magnetization reversal speed in the soft magnetic film. Therefore, by the equation (1), preferably, the ratio between the saturation magnetization (referred to as Ms (Co)) and the anisotropy field (referred to as Hk(Co)) in the Co-based amorphous soft magnetic film 121 (=Ms(Co)/Hk(Co)) and the ratio between the saturation magnetization (Ms(Fe)) and the anisotropy field (Hk(Fe)) in the Fe-based soft magnetic film 122 (=Ms(Fe)/Hk(Fe)) are almost equal to each other. Accordingly, the magnetization reversal speed in the Co-based amorphous soft magnetic film 121 and that in the Fe-based soft magnetic film 122 also become almost equal to each other. Therefore, the assisting action of the magnetization reversal of the Fe-based soft magnetic film 122 is performed more effectively by the Co-based amorphous soft magnetic film 121, and the magnetic permeability of the whole magnetic thin film (the lower and upper magnetic films 12A and 12B) is further improved.

$$\begin{matrix}Equation 1 & \\ \frac{d φ}{d t} ∝ \frac{Ms}{Hk} & ( 1 )\end{matrix}$$

For example, in the case where Ms(Co) is 1.4 T and Hk(Co) is 20 Oe (when the Co-based amorphous soft magnetic film 121 is a CZT film), Ms(Co)/Hk(Co)=0.0700 is established. Consequently, a result as represented in FIG. 17 for example is obtained. Specifically, in the case where Ms(Fe)/Hk(Fe) is almost equal to Ms(Co)/Hk(Co), that is, Ms(Fe)/Hk(Fe) is in the range of 0.0700±0.0040 (0.0660 to 0.0680), the effect of improving the magnetic permeability of the whole magnetic thin film (the lower and upper magnetic films 12A and 12B for example) further increases (the increasing rate of permeability becomes 1.1-fold or higher).

To evaluate the lower magnetic film 12A or the upper magnetic film 12B represented in FIG. 17 (to measure the saturation magnetization Ms and the anisotropy field Hk), a sample vibration magnetometer was used. The sample size was 10 mm by 10 mm, and measurement was performed under the measurement condition that maximum application magnetic field was 20 k [A/m (Oe)] as represented in the magnetization curve of FIG. 18.

In this case, when the ratio between Ms(Fe)/Hk(Fe) and Ms(Co)/Hk(Co) is further defined, the following relational equation (2) is obtained from above. It is therefore preferable to satisfy the following relational equation (3). Further, in consideration of graphs of the Fe proportion dependency of the saturation magnetization Ms(Fe) represented in FIG. 19A and the Co proportion dependency of the saturation magnetization Ms(Co) represented in FIG. 19B, preferably, Fe relative proportion “x” (Fe) in the Fe-based soft magnetic film 122 and Co relative proportion “x” (Co) in the Co-based amorphous soft magnetic film 121 satisfy the following relational equation (4). This is because, in the case where the equations (3) and (4) are satisfied, the magnetization reversal speed in the Co-based amorphous soft magnetic film 121 and that in the Fe-based soft magnetic film 122 also become almost equal to each other, and thus the magnetic permeability of the whole magnetic thin film (the lower and upper magnetic films 12A and 12B for example) further improves.

$$\begin{matrix}Equation ( 2 ) & \\ \frac{0.066}{0.070} ≦ \frac{\frac{{Ms}_{( Fe )}}{{Hk}_{( Fe )}}}{\frac{{Ms}_{( Co )}}{{Hk}_{( Co )}}} ≦ \frac{0.074}{0.070} & ( 2 ) \\ Equation ( 3 ) & \\ 1.18 ≦ \frac{{Ms}_{( Fe )}}{{Ms}_{( Co )}} ≦ 1.32 & ( 3 ) \\ Equation ( 4 ) & \\ 1.18 ≦ \frac{- 0.0017 {x}_{( Fe )}^{2} + 0.2885 {x}_{( Fe )} - 10.434}{- 0.0831 {x}_{( Fe )}^{2} + 15.886 {x}_{( Fe )} - 738.4} ≦ 1.32 & ( 4 )\end{matrix}$$

Although the case of using the Fe—Y—O (FeYO) thin film as the Fe-based soft magnetic film 122 has been described in the foregoing examples, similar characteristic tendency is obtained also in the case where the Fe-based soft magnetic film is made of another material, for the following reason. The granular film is generally an alloy in which a magnetic metal and an oxidized rare-earth metal have different phases. With respect to the metal magnetic phase, the metal magnetic has a granular or columnar structure. In particular, in the case where the proportion of Fe is high, the metal magnetic tends to have the columnar structure for the reason that Fe itself tends to have a bcc structure. On the other hand, since it is considered that Y and O exist in the grain boundaries in the columnar structure, they establish the structure without depending on the relative proportions. Therefore, since the soft magnetic property is determined by the size (thickness) of the columnar structure and the saturation magnetization Ms(Fe) is determined by the content of Fe in the Fe-based soft magnetic film 122, it can be said that similar tendencies are obtained from Fe-based soft magnetic films other than the Fe—Y—O thin film.

As described above, according to the present embodiment, the Fe-based soft magnetic film 122 is formed on the Co-based amorphous soft magnetic film 121 as the soft magnetic film having the magnetic permeability higher than that of the Fe-based soft magnetic film 122. Therefore, the magnetization reversal in the Fe-based soft magnetic film 122 is facilitated, and the magnetic permeability of the whole magnetic thin film (the lower and upper magnetic films 12A and 12B) is improved. In addition, since the thickness ratio between the Co-based amorphous soft magnetic film 121 and the Fe-based soft magnetic film 122 is set in a proper range (from 0.005 to 0.030), the influence of stress from the Co-based amorphous soft magnetic film 122 to the Fe-based soft magnetic film 122 is reduced, and drop in the magnetic permeability of the whole magnetic thin film due to the influence of stress is suppressed. Therefore, the magnetic permeability of the soft magnetic thin film is improved more effectively as compared with the other technique.

In the case where the coercive force (Hc) of the Co-based amorphous soft magnetic film 121 is set to 1.1 Oe or less, the magnetic permeability of the Co-based amorphous soft magnetic film 121 becomes higher. Consequently, the assisting action of the magnetization reversal of the Fe-based soft magnetic film 122 by the Co-based amorphous soft magnetic film 121 is made more effectively. Therefore, the magnetic permeability of the whole magnetic thin film (the lower and upper magnetic films 12A and 12B for example) is further improved.

In the case where the ratio between the saturation magnetization Ms(Co) and the anisotropy field Hk(Co) in the Co-based amorphous soft magnetic film 121 (=Ms(Co)/Hk(Co)) and the ratio between the saturation magnetization Ms(Fe) and the anisotropy field Hk(Fe) in the Fe-based soft magnetic film 122 (=Ms(Fe)/Hk(Fe)) are almost equal to each other, the magnetization reversal speed in the Co-based amorphous soft magnetic film 121 and that in the Fe-based soft magnetic film 122 also become almost equal to each other. In this case as well, the assisting action of the magnetization reversal of the Fe-based soft magnetic film 122 by the Co-based amorphous soft magnetic film 121 is made more effectively. Therefore, in this case as well, the magnetic permeability of the whole magnetic thin film (the lower and upper magnetic films 12A and 12B for example) is further improved.

Although the present invention has been described above with reference to the exemplary embodiment, the invention is not limited thereto but can be variously modified.

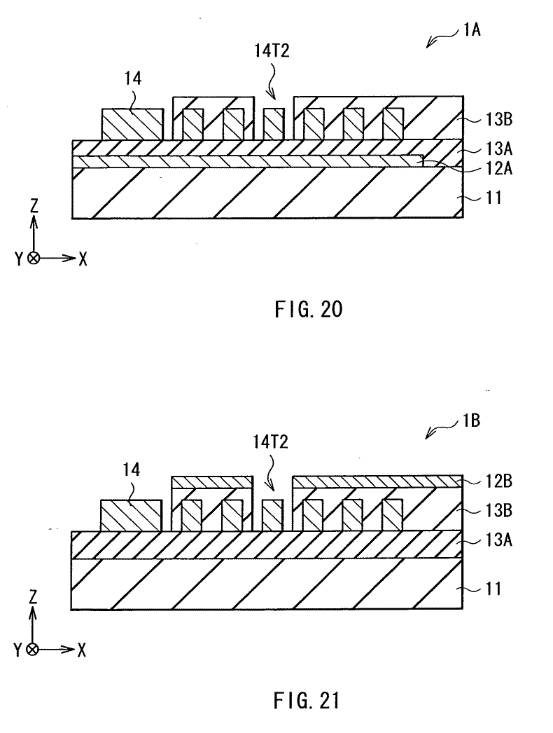

For example, in the above-described embodiment, the thin film inductor 1 in which the magnetic thin films (the lower and upper magnetic films 12A and 12B) according to one embodiment of the invention are provided on both above and below the coil 14 as a thin film coil has been described. However, such a magnetic thin film may be provided on at least one of the sides of extending faces of the coil. For example, the magnetic thin film (lower magnetic film 12A) may be provided only below the coil 14 as in a thin film inductor 1A illustrated in FIG. 20, or the magnetic thin film (upper magnetic film 12B) may be provided only above the coil 14 as in a thin film inductor 1B illustrated in FIG. 21.

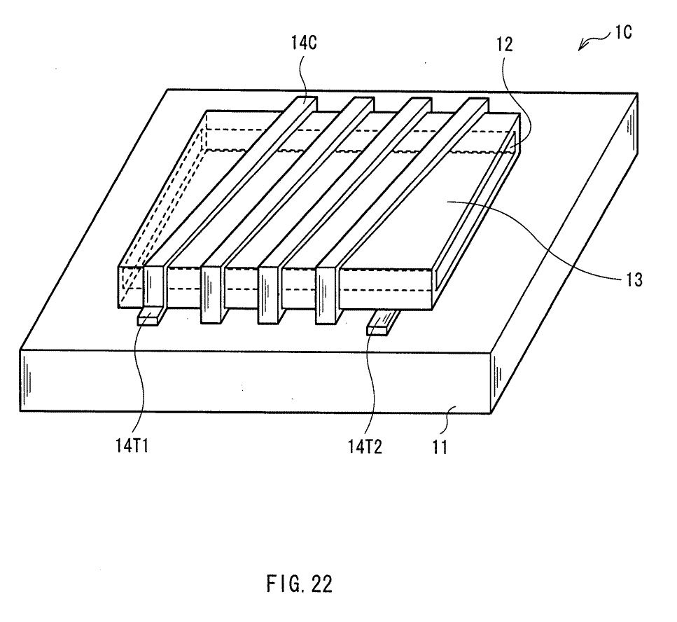

In the above-described embodiment, the case where the coil 14 is a rectangular spiral coil has been described. However, the shape of the coil 14 as a thin film coil is not limited to the rectangular spiral coil. For example, in the case where each of the lower and upper magnetic films 12A and 12B has a circular shape (or ellipse shape) or the like, the coil 14 may be a circular spiral coil. For example, the coil 14 may be a rectangular meander coil. For example, as in a thin film inductor 1C illustrated in FIG. 22, the coil 14 may have a magnetic film 12 corresponding to the lower and upper magnetic films 12A and 12C, and an insulating film 13 corresponding to the lower and upper insulating films 13A and 13B, and the coil may be a solenoid coil 14C.

In the above-described embodiment, the Co-based amorphous soft magnetic film 122 has been described as an example of the soft magnetic film having the magnetic permeability μ higher than that of the Fe-based soft magnetic film 122. However, the invention is not limited thereto.

In the above-described embodiment, the thin film inductor has been described as an example of the thin film magnetic device. The present invention can be also applied to a thin film transformer and the like. That is, as long as a device has the magnetic film described in the foregoing embodiment and a predetermined electrode, the device is not limited to the thin film inductor but may be widely applied as the thin film magnetic device.

Further, the invention is not limited to the materials of the layers, the film forming methods, the film forming conditions, and the like described in the foregoing embodiment. Other materials, other thicknesses, other film forming methods, and other film forming conditions may be also employed.

What is claimed is:

1. A magnetic thin film, comprising:
a first magnetic film formed on a substrate; and
a second magnetic film formed on the first magnetic film,
wherein the first magnetic film is a cobalt-based amorphous soft magnetic film,
the second magnetic film is an iron-based soft magnetic film, and
thickness ratio between the first magnetic film and the second magnetic film (=thickness of the first magnetic film/thickness of the second magnetic film) lies in a range of 0.005 to 0.030 both inclusive.

2. The magnetic thin film according to claim 1, wherein coercive force of the first magnetic film is 1.1 Oe or less.

3. The magnetic thin film according to claim 1, wherein ratio between saturation magnetization (Ms) and anisotropy field (Hk) in the first magnetic film (=Ms/Hk) and ratio between saturation magnetization (Ms) and anisotropy field (Hk) in the second magnetic film (=Ms/Hk) are substantially equal to each other.

4. The magnetic thin film according to claim 1, wherein the iron-based soft magnetic film includes one of iron-M-oxygen based material, where M is one or more metal elements selected from group IIIa, group IVa, and group Va.

5. The magnetic thin film according to claim 4, wherein the metal element M is yttrium.

6. The magnetic thin film according to claim 1, wherein the iron-based soft magnetic film is configured as a granular film.

7. The magnetic thin film according to claim 1, wherein the cobalt-based amorphous soft magnetic film is configured of cobalt-zirconium-tantalum (CoZrTa) or cobalt-zirconium-niobium (CoZrNb).

8. The magnetic thin film according to claim 1, wherein the cobalt-based amorphous soft magnetic film is configured to include a hexagonal crystal with a microcrystal size of 10 nm.

9. A thin film magnetic device, comprising:
a thin film coil; and
a magnetic thin film formed, along a formation plane of the thin film coil, on at least one of an upper side and lower side of the thin film coil,
wherein the magnetic thin film includes:
a first magnetic film formed along the formation plane of the thin film coil; and
a second magnetic film formed on the first magnetic film,
the first magnetic film is a cobalt-based amorphous soft magnetic film,
the second magnetic film is an iron-based soft magnetic film, and
thickness ratio between the first magnetic film and the second magnetic film (=thickness of the first magnetic film/thickness of the second magnetic film) lies in a range of 0.005 to 0.030 both inclusive.

10. A magnetic thin film, comprising:
a first magnetic film formed on a substrate; and
a second magnetic film formed on the first magnetic film,
the first magnetic film is a soft magnetic film having magnetic permeability higher than that of the second magnetic film,
the second magnetic film is an iron-based soft magnetic film, and
thickness ratio between the first magnetic film and the second magnetic film (=thickness of the first magnetic film/thickness of the second magnetic film) lies in a range of 0.005 to 0.030 both inclusive.

11. A thin film magnetic device, comprising:
a thin film coil; and
a magnetic thin film formed, along a formation plane of the thin film coil, on at least one of an upper side and lower side of the thin film coil,
wherein the magnetic thin film includes:
a first magnetic film formed along the formation plane of the thin film coil; and a second magnetic film formed on the first magnetic film,
the first magnetic film is a soft magnetic film having magnetic permeability higher than that of the second magnetic film,
the second magnetic film is an iron-based soft magnetic film, and
thickness ratio between the first magnetic film and the second magnetic film (=thickness of the first magnetic film/thickness of the second magnetic film) lies in a range of 0.005 to 0.030 both inclusive.
